(19) United States
(12) Patent Application Publication
(10) Pub. No.: US 2007/0236149 A1
(43) Pub. Date: Oct. 11, 2007

(54) IMAGE DISPLAY APPARATUS

(76) Inventor: Masataka TSUNEMI, Isesaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/763,484

(22) Filed: Jun. 15, 2007

Related U.S. Application Data
(63) Continuation of application No. PCT/JP05/22767, filed on Dec. 12, 2005.

(30) Foreign Application Priority Data
Dec. 15, 2004 (JP) 2004-363444

(51) Int. Cl. G09G 3/10

(52) U.S. Cl. 315/169.1; 315/169.2

(57) ABSTRACT

In an image display apparatus according to the present invention, surge absorbers are connected between each of first and second scanning line drivers which supply a predetermined voltage to scanning lines of a display panel and the respective scanning lines. One ends of the individual surge absorbers are connected to ground. When discharge occurs between a rear panel, namely, a first substrate and a faceplate, namely, a second substrate which may occur according to the structural feature of the panel, the individual surge absorbers can prevent the first and the second scanning line drivers from being damaged by a discharge current generated by the discharge.

### CROSS-REFERENCE TO RELATED APPLICATIONS

This is a Continuation Application of PCT Application No. PCT/JP2005/022767, filed Dec. 12, 2005, which was published under PCT Article 21(2) in Japanese.

This application is based upon and claims the benefit of priority from prior Japanese Patent Application No. 2004-363444, filed Dec. 15, 2004, the entire contents of which are incorporated herein by reference.

### BACKGROUND OF THE INVENTION

1. Field of the Invention

The present invention relates to an image display apparatus. More particularly, the invention relates to an image display apparatus which has an electron source and a fluorescent surface to display an image by emitting an electron beam, in a vacuum housing.

2. Description of the Related Art

A CRT (cathode-ray tube), which is widely used as an image display apparatus, emits an electron beam to fluorescent elements to light the fluorescent elements, and displays an image as a result.

There has been developed an image display apparatus provided with many electron-emitting elements side (electron source side) substrate which selectively emit electron beams to a plane like fluorescent screen side (front surface) substrate arranged in a plane and opposed across a predetermined interval, and outputs fluorescence (displays an image). This type image display apparatus is called an FED (field emission display). In an FED, a display apparatus using a surface transmission emitter as an electron source is classified as an SED (surface transmission type electron emission display). In this application, the term FED is used as a generic name including an SED.

The FED can be made by setting a clearance between an electron source substrate and a fluorescent surface substrate to several millimeters or less. Therefore, an FED can be made thinner than a well-known CRT, and equivalent to or thinner than a flat display unit like an LCD (Liquid Crystal Display). Accordingly, the FED can be made light in weight. Further, the FED is a self-emission type like a CRT and a PDP (Plasma Display Panel), and displays an image with high brightness.

On the fluorescent surface provided inside the front surface substrate, R (red), G (green) and B (blue) fluorescent substances are arranged in predetermined size and order. Each fluorescent substrate on the fluorescent surface is connected to an anode electrode to give each fluorescent substance a predetermined sweep voltage.

On the electron source side substrate, a scanning line and signal line are connected like a matrix to let a specific emitter emit a predetermined amount of electron to illuminate a fluorescent surface opposite to an emitter at an optional position.

In the FED, the light of image output from a fluorescent substance reflects on a display surface of a front surface substrate or a visible surface for an observer, and increases to brightness of an image. Therefore, a metal back layer that is a thin layer of metallic material is provided on a fluorescent substance, or on the side opposite to an electron source substrate in the assembled state.

A metal back layer functions as an anode for an electron source, or an emitter.

For example, in Jpn. Pat. Appln. KOKAI Publication No. 2002-221933, a display panel and a driving unit for driving the display panel are provided. In the display panel, a display apparatus including a plurality of scanning lines extending laterally or in a horizontal direction, a plurality of signal lines crossing the individual scanning lines and extending longitudinally or in a vertical direction, and a plurality of display pixels disposed at crossing positions of the respective scanning lines and the respective signal lines.

It should be noted that in an FED, according to its structural feature, a high voltage of around 10 kV is applied between a front substrate and an electron source side substrate. Therefore, it is known that vacuum arc discharge (may be simply called “arc discharge”) in which a discharge current with magnitude reaching to 100 A may flow is easy to occur between a metal back layer, namely, an anode and an electron source, namely, an emitter.

As a proposal regarding this metal back layer, in Jpn. Pat. Appln. KOKAI Publication No. 10-326583, it is shown that after divided into a plurality of pieces, the metal back layer is connected with an anode power supply which is a common electrode via an interposed resistance member to secure an anode voltage.

It should be noted that securing an anode voltage is achieved by blocking vacuum arc discharge from occurring.

Further, in Jpn. Pat. Appln. KOKAI Publication No. 2000-311642, a method of forming a zigzag pattern on a metal back layer to raise effective impedance on a phosphor surface is disclosed.

However, even by the methods reported in the above documents of Jpn. Pat. Appln. KOKAI Publication No. 10-326583 and Jpn. Pat. Appln. KOKAI Publication No. 2000-311642, in connection with an interval between a front substrate (also called “faceplate”) and an electron source side substrate (also called “rear panel”) or a magnitude, a temporal change, and the like of a voltage applied to an anode, it is difficult to completely prevent generation of discharge. Further, though a magnitude of a discharge current generated when discharge occurs is progressing to suppression, it is difficult to completely prevent a discharge current larger than a discharge current with such a magnitude that the discharge current does not influence image display from flowing.

It should be noted that when a discharge current flows in a lateral direction, namely, in a scanning line direction, a beard-like damage is frequently generated.

### BRIEF SUMMARY OF THE INVENTION

An object of the present invention is to reduce generation of discharge between substrates, and when discharge occurs, to suppress a magnitude of a discharge current to reduce damage of an electron source, a phosphor surface, and a driving circuit, and degradation of an emission characteristic in an image display apparatus.

This invention is provided an image display apparatus comprising: a first substrate holding an electron beam source; a second substrate holding a phosphor which is irradiated with an electron beam output from the electron beam source to output light with a predetermined color, and opposing the first substrate at a predetermined interval; a frame member airtightly holding the first substrate and the second substrate at a predetermined interval; a scanning line which supplies a predetermined voltage to a pixel defined by the phosphor of the second substrate; a signal line which supplies a predetermined voltage to the pixel defined by the phosphor of the second substrate; a scanning line driving circuit which applies a predetermined voltage to the scanning line; and a surge absorber provided on the scanning line, and connected to ground when a voltage larger than a predetermined voltage occurs, or when a current larger than a specified current value flows.

Also, this invention is provided an image display apparatus comprising: a display panel provided with a plurality of scanning lines, a plurality of signal lines perpendicular to the scanning lines, and a plurality of display pixels disposed in the vicinity of positions at which the scanning lines and the signal lines cross each other, and including surface-conduction type electron-emitters which emit electron beams in response to pixel voltages between respective pairs of the scanning lines and the signal lines;

a scanning line driving circuit which supplies a predetermined voltage to individual scanning lines of the display panel; and surge absorbers which are provided between the scanning lines and the scanning line driving circuit or in arbitrary sections between the scanning lines and connecting portions between the scanning lines and individual display pixels of the display panel, and which prevents the discharge current from flowing into the scanning line driving circuit when discharge occurs in the display panel.

Further, this invention is provided an image display apparatus, comprising: a first substrate holding an electron beam source, a second substrate holding a phosphor layer which is irradiated with an electron beam output from the electron beam source to output light with a predetermined color, and opposing the first substrate at a predetermined interval, and a side wall making a structure of the first substrate and the second substrate closed, wherein a protection circuit which cuts an electric connection between a driving circuit and the second substance and first substance when an abnormal voltage exceeding a predetermined voltage occurs, when the abnormal voltage flows, or a potential rising which leads to generation of the abnormal voltage occurs between the driving circuit that provides a signal for the image display between the second substrate and the first substrate is provided.

### BRIEF DESCRIPTION OF THE SEVERAL VIEWS OF THE DRAWING

FIG. 1 is a schematic view showing one example of a circuit configuration of a planar image display apparatus to which the present invention is applied;

FIG. 2 is a schematic view showing one example of a structure of a display panel of the image display apparatus shown in FIG. 1;

FIG. 3 is a sectional view of the display panel of the image display apparatus shown in FIG. 2 taken along I-I;

FIG. 4 is a schematic view showing one example of a configuration of a display surface of the display panel shown in FIG. 2 and FIG. 3;

FIG. 5 is a partially enlarged schematic view of the display surface of the display panel shown in FIG. 4; and

FIG. 6 is a schematic view showing one example of arrangement examples of an anode electrode and a getter layer, namely, a sweep electrode of the display panel shown in FIGS. 2 to 5.

### DETAILED DESCRIPTION OF THE INVENTION

Hereinafter, with reference to the figures, an embodiment of the present invention will be explained in detail.

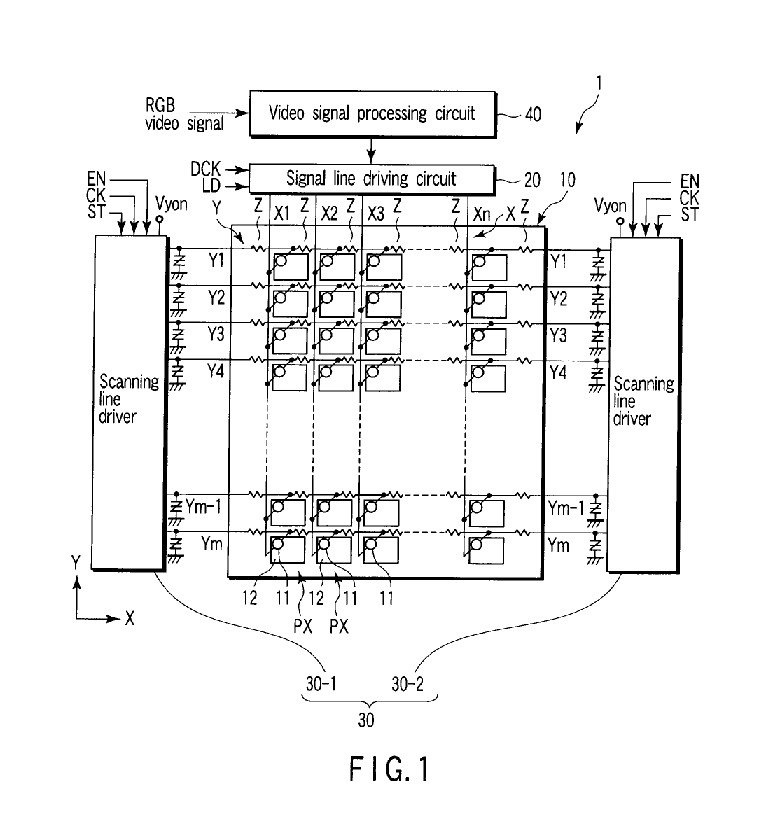

FIG. 1 shows one example of a circuit configuration of a planar image display apparatus to which the present invention is applied. An image display apparatus 1 shown in FIG. 1 is an FED (Field Emission Display) apparatus having the color display pixel number of, for example, 1280 in width by 768 in height. The image display apparatus 1 is provided with a display panel 110, a signal line driving circuit 20, a scanning line driving circuit 30, and a video signal processing circuit 40.

The display panel 10 includes 768 scanning lines Y (m=768, Y1 to Ym) provided approximately in parallel with each other in a lateral, namely, a horizontal direction (hereinafter called the “Y direction”), and 1280×3 signal lines X (n=1280, X1 to Xn) provided in a longitudinal, namely, a vertical direction (hereinafter called the “X direction”) perpendicular to the scanning lines Y1 to Ym. Positions at which the respective scanning lines Y1 to Ym and the respective signal lines X1 to Xn are provided with m×n (=about 2,760,000) display pixels PX. The respective display pixels PX include three display pixels PX (R, G, B) adjacent to one another in the Y direction.

The individual display pixels PX (each of R, G, and B) of the display panel 10 include Surface-Conduction type Electron-Emitters (which may be simply called “emitters” or “electron-emitters”) 11 and phosphors 12 (R, G, B) each of which emits light of R (red), B (blue), or G (green) color due to reception of an electron beam emitted from the respective emitters 11.

The individual scanning lines Y1 to Yn are connected to the electron-emitters 11 of the display pixels PX in a corresponding line, namely, a row, and used as scanning electrodes. The individual signal lines X1 to Xn are connected to the electron-emitters 11 of the display pixels PX in a corresponding line, namely, a column, and used as signal electrodes.

The signal line driving circuit 20, the scanning line driving circuit 30, and the video signal processing circuit 40 are provided around the display panel 10. It should be noted that the respective circuits are supplied with a control signal and an image signal from a timing controller (not shown) to cause the display panel 10 to operate. That is, light with a predetermined color according to the image signal is emitted from the individual display pixels PX of the display panel 10 to display a moving image or a still image on the whole.

The video signal processing circuit 40 processes video signals including R, G, and B signals supplied from a signal source (not shown). The scanning line driving circuit 30 uses scanning signals to drive the scanning lines Y1 to Ym sequentially, and the signal line driving circuit 20 drives the signal lines X1 to Xn in response to the video signal from the video signal processing circuit 40 while each of the scanning lines T1 to Ym is driven by the scanning line driving circuit 30.

The scanning line driving circuit 30 includes first and second scanning line drivers 30-1 and 30-2 disposed on a left end side and a right end side of the scanning lines Y1 to Ym, respectively. The first scanning line driver 30-1 is connected to left ends of all the scanning lines Y1, Y2, Y3, . . . , Ym-1, and Ym to drive the respective scanning lines Y1, Y2, Y3, . . . , Ym-1, and Ym from their left end. The second scanning line driver 30-2 is connected to right ends of all the scanning lines Y1, Y2, Y3, . . . , Ym-1, and Ym to drive these scanning lines Y1, Y2, Y3, Y4, Y5, . . . , Ym-1, and Ym from their right ends.

It should be noted that the respective scanning lines Y1 to Ym connecting the respective first and second scanning line drivers 30-1 and 30-2 with the display panel 11 are connected with surge absorbers Z1 to Zm, respectively, and one ends of the respective surge absorbers are connected to ground. When discharge, especially vacuum arc discharge occurs between substrates, namely, between a rear panel 100 and a faceplate 200 of the display panel 10 which may be caused according to the structural feature of the display panel 10 explained below, the surge absorbers Z1 to Zm can prevent the scanning line drivers 30-1 and 30-2 from being damaged by an overcurrent which is a discharge current generated by the discharge. That is, since the overcurrent flows to the surge absorbers in short-circuited lines, the overcurrent does not turn around into the scanning drivers.

The surge absorbers Z1 to Zm are elements which can provide an avalanche effect, for example, they are avalanche diodes or avalanche transistors. It should be noted that the surge absorbers Z1 to Zm are preferably provided at connection ends with the scanning line driving circuit on the display panel side explained below or in the vicinity thereof instead of in the vicinity of the scanning line driving circuit 30. Further, when drivers IC used for the scanning line driving circuit 30 are provided, for example, on both sides in a longitudinal direction of the display panel 10, it is preferable that two sets of the surge absorbers Z1 to Zm to be provided close to the respective scanning line drivers (30-1 and 30-2).

The scanning drivers 30-1 and 30-2 include m output ends respectively connected to the left ends of the scanning lines Y1, Y2, Y3, . . . , Ym-1, and Ym and output ends respectively connected to the right ends of the scanning lines Y1 Y2, Y3, . . . , Ym-1, Ym, respectively, and sequentially output scanning signals to the m output ends, respectively.

For example, as for one of two adjacent frame periods, ST (start signal), CK (clock signal), and EN (enable signal) are supplied to the scanning line driver 30-1 from a timing controller (external apparatus, not shown). Therefore, the scanning driver 30-1 is allocated to all the scanning lines Y1, Y2, Y3, Y4, Y5, . . . , Ym-1, and Ym.

Similarly, as for the other frame period of two abutting frame periods, a start signal ST, a clock signal CK, and an enable signal EN are supplied to the scanning line driver 30-2 by the timing controller. Thereby, the scanning driver 30-2 is allocated to all the scanning lines Y1, Y2, Y3, Y4, Y5, . . . , Ym-1, and Ym.

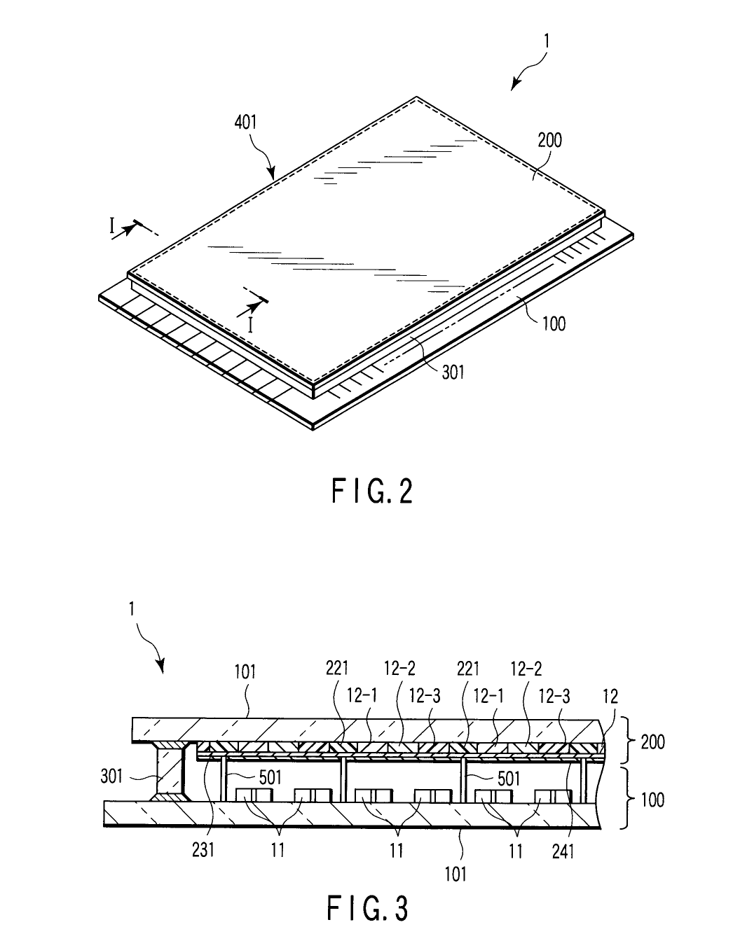

FIG. 2 and FIG. 3 show one example of a structure of the display panel incorporated in the image display apparatus shown in FIG. 1.

Though explained above, the display panel 10 includes a first substrate, namely, an electron source side substrate 100 (hereinafter called a “rear panel”) and a second substrate, namely, a phosphor screen side substrate 200 (hereinafter called a “faceplate”). Though explained above, the rear panel 100 includes electron sources, namely, emitters 11. Similarly, though explained above, the faceplate 200 includes phosphor screens 12 including phosphors of R, G, and B which are opposite to the rear panel at predetermined intervals and hit by an electron beam to output fluorescence.

As shown in FIG. 3, the rear panel 100 includes a rectangular glass board material 101 given a predetermined area, and a main portion of a planar portion of the glass board material 101, namely, a portion corresponding to a display region is provided with a predetermined number of electron sources, namely, the electron-emitters explained above. As shown in FIG. 3, the faceplate 200 includes a rectangular glass substrate material 201 given a predetermined area, and a main portion of a planar portion of the glass board material 101, namely, a region used as an image display region is provided with a predetermined number of display pixels which produce emission patterns defined by an arrangement of the phosphors (R, G, B) already explained.

The rear panel 100 and the faceplate 200 is opposite to each other at an interval of 1 to 2 mm and joined to each other by a side wall 301. The side wall 301 is adhered to the rear panel 100 and the faceplate 200 by an adhesive which is not described in detail to become a part of an outer case 401 with a sealed structure. It should be noted that the degree of vacuum inside the outer case 401 is defined to, for example, about 10⁻⁴ Pa.

Many spacers 501 formed into a plate shape or a column shape are disposed between the glass board material 101 of the rear panel 100 and the glass substrate material 201 of the faceplate 200. By these spacers, the glass board materials can endure atmosphere pressure acting on the respective glass board materials in a state of being assembled as the outer case 401.

One surface of the glass substrate material 201 used for the faceplate 200, namely, a surface facing inside when assembled as the outer case 401 is provided with a phosphor screen 211 where the respective phosphors 12 of R, G, and B described above are arranged in a predetermined order.

The phosphor screen 211 is provided with a metal thin film, namely, a metal back layer functioning as an anode. It should be noted that a sweep voltage of, for example, 10 to 15 kV is applied between the anodes and the emitters of the rear panel 100.

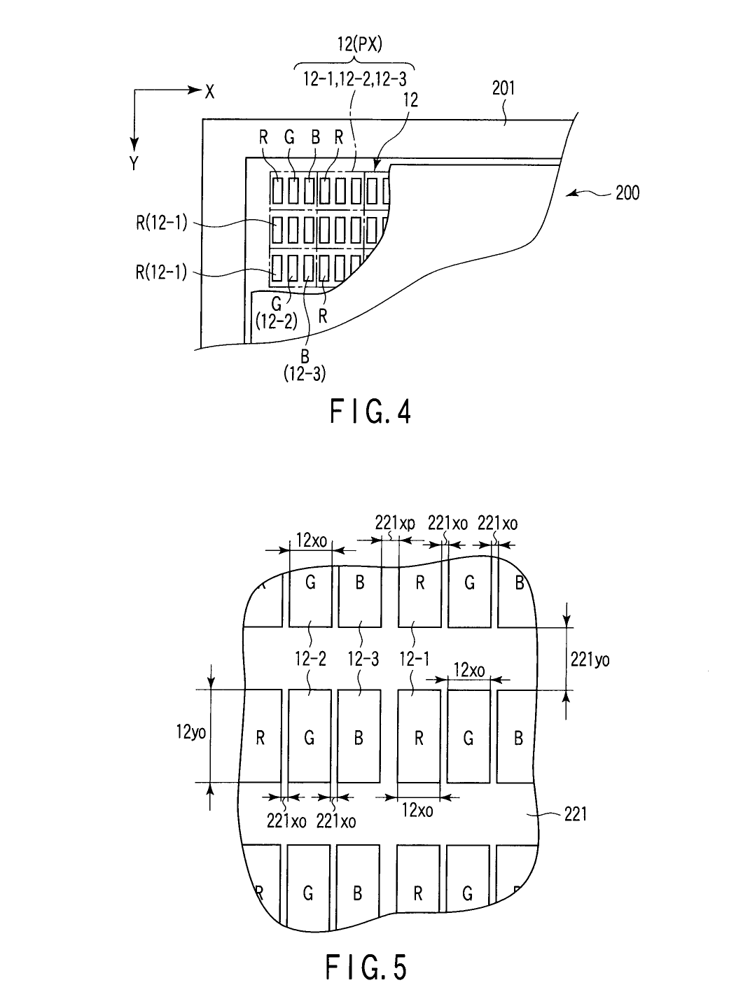

Further, the phosphor screen 211 is provided with phosphors 12-1 (for example, R), 12-2 (for example, G), and 12-3 (for example, B) which are hit by electrons emitted from each emitter of the rear panel 100 to emit light of R, G, and B respectively and a black mask, namely, a light blocking layer 221 arranged in a matrix pattern for partitioning the respective phosphors. It should be noted that respective colors of the phosphors 12-1, 12-2, and 12-3 are arbitrary, and an example of the arrangement shown in FIG. 4 and FIG. 5 is one embodiment.

When a longitudinal direction of the faceplate 200 is defined as a first direction, namely, an X direction, and a widthwise direction thereof perpendicular to the X direction is defined as a second direction, namely, a Y direction, the respective phosphors 12-1, 12-2, and 12-3 are formed into, for example, stripes extending in the Y direction. Though explained above, three of the respective phosphors 12-1, 12-2, and 12-3 are arranged as a unit.

The light blocking layer 221 is a mixture of, for example, carbon and binder material, and its resistance value is set to, for example, 10³ to 10⁸ [Ω]. It should be noted that a binder material content is defined to 80% to the maximum.

In the light blocking layer 221, as can be easily determined from FIG. 4 and FIG. 5, a width 221xₚ of a portion partitioning one display pixel 12 (PX) made of three colors as a unit is formed in the X direction, namely, a column direction to be wider than a width 221xₒ of a portion for dividing any one color. Further, a width 221yₒ of a portion for partitioning one display pixel with respect to the Y direction, namely, a row direction perpendicular to the X direction is formed to be wider than the width 221xₚ of the portion dividing one display pixel in the X direction. It should be noted that a size in the Y direction of the individual phosphors extending like a strip, namely, a length yₒ of the phosphor which displays one color is formed to be larger than the width 221yₒ in the X direction of the light blocking layer 221.

In one example where a size of one display pixel PX is set to 0.6×0.6 mm, the width 221xₒ of the portion for dividing any one color is 20 to 100 μm, more preferably 40 to 50 μm, while a remaining portion, namely, the width 221xₚ of the portion dividing one display pixel 12 is 20 to 100 μm, more preferably 20 to 30 μm. Further, the width 221yₒ in the X direction of the light blocking layer 221 is 150 to 450 μm, more preferably 300 μm. Therefore, a length 12yₒ of the phosphor for displaying any one color is defined to about 300 μm, and a width 12xₒ of the phosphor for displaying any one color is defined to about 150 μm.

On the phosphor screen 211, a metal thin layer, namely, a metal back layer 231 provided on the whole surface covering the respective phosphor regions 12-1, 12-2, and 12-3 partitioned by the light blocking layer 221, functioning as an anode as explained below in the phosphor region whose surface has undulation, and used to reflect light emitted in the respective phosphor regions on the glass substrate 201 side is formed to have a predetermined thickness. It should be noted that since the term “metal back layer” is not limited to metal as long as it can function as an anode, various material can be used. Further, before the metal back layer 231 is formed, a smoothing layer where phosphor particles such as resin can fix each other may be provided on the whole surface of a phosphor region.

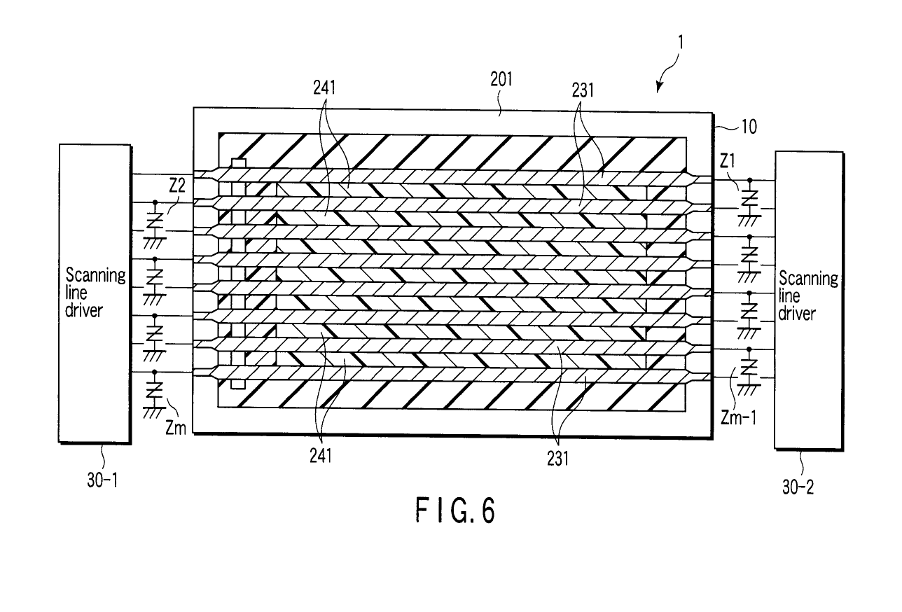

As shown in FIG. 6, it is preferable that the metal back layer 231 and a getter layer stacked on the metal back layer 231, namely, an impurity absorption layer 241 be divided like stripes along at least one direction of the X direction and the Y direction. It should be noted that the term “divided” means that there is no electrical continuity. That is, in even a material widely classified as insulator, its resistance value does not reach infinity. Therefore, in a strict sense, complete electrical division is difficult, and in the present application, a state in which electrical characteristic is discontinuous up to at most the upper limit of a voltage applied on between an emitter and an anode, namely, the sweep voltage is referred to as “divided”. It should be noted that the sweep voltage is also called “anode voltage”. In other words, a state in which, even when the sweep voltage is applied, resistance is significantly high as compared with a state of a continuous film so that discharge is difficult to occur is referred to as “divided”.

When an anode voltage is applied and unwanted arc discharge occurs between the rear panel 100, namely, the glass board material 101 and the faceplate 200, namely, the glass board material 201, sparks (discharge locus) generated by discharge current and discharge frequently flows in the X direction along the scanning lines. In view of such a background, though already explained with reference to FIG. 1, it is beneficial that the scanning lines Y1 to Ym are inserted with the surge absorbers Z1 to Zm, respectively.

According to the FED, namely, the display panel configured as described above, generation of unwanted discharge, unwanted rising of a scanning line potential between the metal back layer which is a metal thin film functioning as a sweep electrode and the getter layer and the emitters provided on the substrate opposite to the metal back layer and the getter layer, or application of overvoltage to the emitters due to generation of discharge can be prevented. Further, the scanning line drivers, the individual display pixels, or the display surface (phosphor) can be prevented from being damaged by overcurrent generated by discharge. That is, according to the present invention, since the surge absorber which can prevent a discharge current from occurring substantially is used against the condition that discharge occurs between the substrates, generation of beard-like damage due to discharge can be prevented. That is, damaging the electron-emitter or the phosphor surface or degrading its property can be prevented. Therefore, the image display apparatus whose image quality is less degraded can be manufactured.

As explained above, by adopting the above-described structure, a magnitude of a discharge current can be suppressed even if discharge occurs. Thereby, damaging an electron-emitter, a phosphor surface and a driving circuit or degrading its characteristic can be prevented. As a result, an image display apparatus whose image quality is not degraded due to that discharge occurs inside can be obtained.

The invention is not limited to the aforementioned embodiments. Various modifications and variations are possible in a practical stage without departing from its essential characteristics. Each embodiment may be appropriately combined as far as possible. In such a case, the effect by the combination is obtained.

What is claimed is:

1. An image display apparatus comprising:
a first substrate holding an electron beam source;
a second substrate holding a phosphor which is irradiated with an electron beam output from the electron beam source to output light with a predetermined color, and opposing the first substrate at a predetermined interval;
a frame member airtightly holding the first substrate and the second substrate at a predetermined interval;
a scanning line which supplies a predetermined voltage to a pixel defined by the phosphor of the second substrate;
a signal line which supplies a predetermined voltage to the pixel defined by the phosphor of the second substrate;
a scanning line driving circuit which applies a predetermined voltage to the scanning line; and
a surge absorber provided on the scanning line, and connected to ground when a voltage larger than a predetermined voltage occurs, or when a current larger than a specified current value flows.

2. The image display apparatus according to claim 1, wherein the surge absorber includes an element which provides an avalanche effect.

3. The image display apparatus according to claim 1, wherein the surge absorber is provided in the vicinity of the second substrate or on a connecting portion between the second substrate and the scanning line driving circuit.

4. The image display apparatus according to claim 1, wherein the pixel includes a surface-conduction type electron-emitter which emits an electron beam.

5. An image display apparatus comprising:
a display panel provided with a plurality of scanning lines, a plurality of signal lines perpendicular to the scanning lines, and a plurality of display pixels disposed in the vicinity of positions at which the scanning lines and the signal lines cross each other, and including surface-conduction type electron-emitters which emit electron beams in response to pixel voltages between respective pairs of the scanning lines and the signal lines;
a scanning line driving circuit which supplies a predetermined voltage to individual scanning lines of the display panel; and
surge absorbers which are provided between the scanning lines and the scanning line driving circuit or in arbitrary sections between the scanning lines and connecting portions between the scanning lines and individual display pixels of the display panel, and which prevents the discharge current from flowing into the scanning line driving circuit when discharge occurs in the display panel.

6. The image display apparatus according to claim 5, wherein the pixels include surface-conduction type electron-emitters which emit electron beams.

7. The image display apparatus according to claim 5, wherein the scanning line driving circuit is provided on both sides of a pixel column of the display pixels of the display panel.

8. The image display apparatus according to claim 5, wherein the surge absorbers include elements which provide an avalanche effect.

9. An image display apparatus, comprising:
a first substrate holding an electron beam source, a second substrate holding a phosphor layer which is irradiated with an electron beam output from the electron beam source to output light with a predetermined color, and opposing the first substrate at a predetermined interval, and a side wall making a structure of the first substrate and the second substrate closed, wherein
a protection circuit which cuts an electric connection between a driving circuit and the second substance and first substance when an abnormal voltage exceeding a predetermined voltage occurs, when the abnormal voltage flows, or a potential rising which leads to generation of the abnormal voltage occurs between the driving circuit that provides a signal for the image display between the second substrate and the first substrate is provided.
